(19) United States
(12) Patent Application Publication
(10) Pub. No.: US 2012/0284074 A1
(43) Pub. Date: Nov. 8, 2012

(54) Method and Apparatus for Business Planning & Prediction Using Value Rank

(76) Inventors: Matthew R. Shanahan, Seattle, WA (US); Peter H. Horadan, Redmond, WA (US)

(21) Appl. No.: 13/102,481

(22) Filed: May 6, 2011

(51) Int. Cl. G06Q 10/00; G06Q 30/00

(52) U.S. Cl. 705/7.13; 705/7.29; 705/7.12; 705/14.49

(57) ABSTRACT

Users of a subscription product or service are ranked according to the value they receive from the service (computed as the ratio between worth received and cost). Users with similar value ranks are identified as likely to experience similar relationship events. This identification is acted upon by scheduling a workflow (e.g., a sales call or special price offer) designed to encourage or discourage the similar relationship event from occurring with the identified users. Value-ranked users can also be used to understand the effectiveness of marketing and lead-development activities, and to help plan and allocate advertising budgets to achieve particular customer characteristics.

### FIELD

The invention relates to collecting and processing information during the operation of a business to improve the accuracy of planning and prediction to further guide the business's operations. More specifically, the invention relates to methods for analyzing data about customers' use of products or services to learn how to find or serve particular customers better.

### BACKGROUND

Many businesses offer their products or services to customers on a subscription basis. A magazine or newspaper subscription is perhaps the canonical example, but everything from gym memberships to fruit baskets, DVD movies and streaming stock data can be obtained by subscription. A subscriber to an offering is an important type of customer for a business, because subscription fees represent recurring revenue—money the business can expect to receive every month while the customer remains satisfied with the product.

For some products (such as magazines, fruit baskets and stock data), every subscriber receives a similar or identical item. For others (gym memberships, online database access) the subscriber merely has the right to use a product or service while his subscription is current. This latter type of subscriber likely represents a variable cost for the business, and receives a variable benefit from his subscription. The variability complicates business planning: the enterprise must ensure that adequate resources are available to serve potential users, and must consider that a subscriber who receives little benefit may cancel his subscription, regardless of his satisfaction with the underlying service or product. For example, a gym member who rarely exercises there may decide that the value he receives does not justify the expense, regardless of the quality and convenience of the facilities.

It is a common business maxim that an existing customer is much more valuable than a potential customer, so successful businesses strive to retain customers, and variable-value subscription-based business must work especially hard at this. And, as a corollary to the “valuable customer” maxim, it is also important for a business to direct its marketing efforts toward potential customers who are likely to become long-term clients. Analytical tools and techniques to support marketing-planning and customer retention may be of substantial benefit to many businesses.

### SUMMARY

Embodiments of the invention collect information about subscribers' use of a company's products or services and calculate a value-received estimate for each subscriber. The value-received estimates are ranked, and events affecting the relationship between a subscriber and the company are correlated with the affected subscriber's value-received rank. Finally, the correlations are used to predict the likelihood of similar events occurring in the company-subscriber relationship of a customer with a similar value-received rank. The prediction may be used to trigger a business process intended to encourage (or discourage) the predicted event, or to identify lead sources that produced desirable or undesirable customers, for the purpose of allocating marketing resources among the lead generation programs.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flow chart outlining operations according to an embodiment of the invention.

FIG. 2 is a sample graph ordering a population of customers by their Value Rank as computed according to an embodiment of the invention.

FIG. 3 shows a distributed environment where an embodiment of the invention may be operated.

FIG. 4 illustrates several different options for selecting customers from among a plurality of customers.

FIG. 5 is a flow chart outlining an extension to the inventive method to obtain additional information from the collected data.

### DETAILED DESCRIPTION

Businesses have long collected information about their customers and used it to direct sales and marketing efforts. For example, it is not difficult to see that a customer who purchases a bicycle might be a good target for an offer of a discount on a helmet. Similarly, ad campaign results are closely scrutinized to determine, for example, whether an expensive placement in a national newspaper yields more profitable business than a cheaper notice in a local magazine. Embodiments of the invention also collect data and make predictions, but the information is more subtly related to business outcomes, so it must be analyzed carefully and acted upon judiciously to obtain the benefit available. Nevertheless, the methods described here are useful to help a business operate reliably and predictably, rather than relying on the intuitions and hunches of “good” salespeople. (Of course, the value of the information and predictions can be amplified by the actions of a skilled sales force, but even a mediocre business development staff can improve its results by following the method described here.)

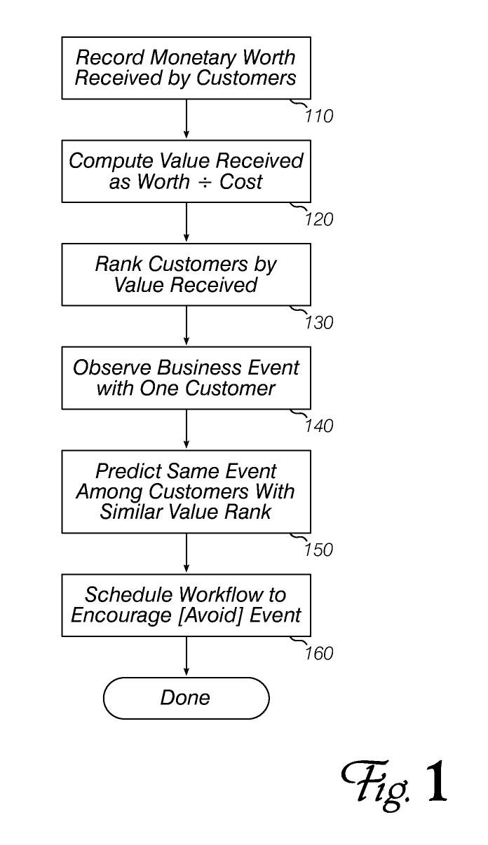

The general, high-level operation of embodiments of the invention is illustrated in the flow chart of FIG. 1. This method may be applied by a business that sells products or services to a plurality of customers on a subscription basis. That is, each customer pays a periodic subscription fee and receives—or has the right to receive—some goods or services during the period. A common length of a subscription period is one month, and that length will be assumed in many of the examples to follow, but it is appreciated that businesses that offer subscriptions of any length, or even aperiodic subscriptions, can apply these methods.

The business monitors each subscriber's use of the goods or services to determine the monetary worth each receives (110). The worth is often unrelated to the subscription fee, and may be difficult to fix exactly. However, for goods and services that are also offered on a cash-and-carry or pay-per-use basis, the worth received by a subscriber can be estimated easily and accurately by referring to the charge a non-subscriber would incur to obtain the same item or service.

Next, for each subscriber, the value received by the subscriber is computed as the monetary worth of all goods and services received over a period, divided by the subscription fees paid for the same period (120). Note that the value received is often different, even among subscribers who pay the same periodic fee. It is appreciated that a subscriber to a low-cost plan could well receive greater value under this measure than a subscriber to a high-cost plan, or vice versa.

Continuing, the subscribers are ranked according to the value each received during the study period (130). Now, an event of interest affecting the relationship between the business and one of the subscribers is observed (140). For example, one of the subscribers may cancel his subscription, or may change to a different subscription plan. An embodiment identifies other subscribers who have similar value-received ranks as the subscriber whose interesting event was observed (150), and an entry is made in a business workflow scheduling system to encourage (or discourage) the event from occurring with the other subscribers (160).

The process outlined in FIG. 1 is not foolproof: its predictions may not be correct, and the actions scheduled in response to a prediction may not succeed in convincing (or dissuading) the other subscribers. However, the inventors' experience with developing and testing the process suggests that it provides useful guides to allocating resources, compared to randomly contacting customers or pursuing targeted strategies based on simpler criteria such as “all subscribers at the $100/month level” or “all subscribers who have been customers for 12 to 15 months.”

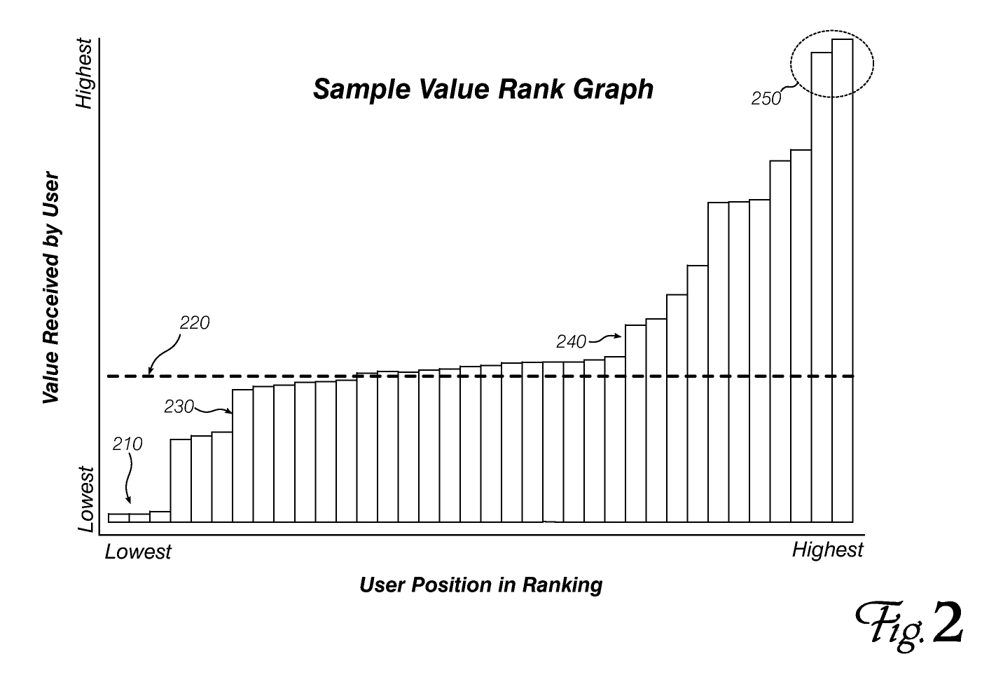

FIG. 2 shows a sample graph of a value-ranked group of customers. Each vertical bar represents the value a customer received over the period of time under study. The customers are sorted by increasing value received, so the graph is monotonically increasing. Customers with very low value rank (210) receive little value from their subscriptions (perhaps they rarely or never used the goods or services during the study period). Dashed line 220 indicates a value-received of unity: customers whose value-received score is less than the dashed line would have benefited by purchasing the goods or services on a per-unit or per-instance basis (according to their usage and the monetary-worth assignment basis used for the valuation), while customers whose value-received score is greater than the dashed line got more (by the same criteria) than they paid for. Discontinuities in the graph (e.g., 230, 240) may correspond to different subscription pricing tiers. Customers with very high value rank (250) may be exploiting their access unfairly; such cheating may also be detected by the method disclosed in a co-pending provisional application entitled “Method and Apparatus for Protecting Online Content by Detecting Noncompliant Access Patterns,” by one of the inventors of the present invention (Horadan).

Note that a value-ranking graph such as that shown in FIG. 2 does not indicate whether the business offering the subscription is making a profit by doing so. It only indicates whether the ranked customers are receiving goods or services worth (by a possibly-arbitrary accounting) more or less than they paid.

The sorting by value rank may move customers away from others who are similar in other respects. For example, customers who pay the same periodic subscription fee, who have been subscribers for similar periods of time, or who were originally contacted through the same marketing channel, may end up at widely different locations in the ranking. The essence of an embodiment of the invention is grouping customers together by their value rank, then making predictions or taking actions based on this grouping, rather than other conventional groupings.

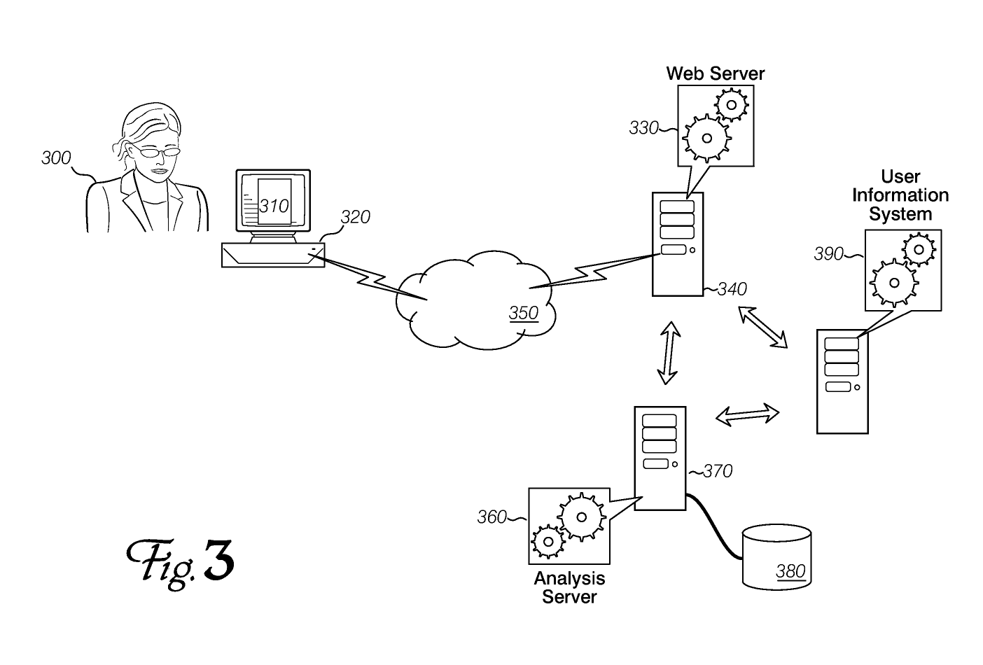

FIG. 3 shows a sample environment and data-processing infrastructure where an embodiment of the invention is deployed. In this example, the business provides online access to real-estate information: listings of properties for sale, recent sales closings, tax and zoning records, and so forth. Customers can purchase individual records or subscribe to get unlimited access for varying periods (e.g., 24 hours, one month, or month-to-month with automatic renewal).

A customer 300 uses a web browser 310 running at her computer 320 to contact a web server 330 at a remote computer 340 over a distributed data communication network such as the Internet 350. Computer 340, which is operated by the business, interacts with customer 300, offering menus, performing searches, accepting selections and allowing customer 300 to download the information she desires.

Web server 330 establishes a session ID for interactions with user 300 and upon each page view of the web-based application, web server 330 sends a message to analysis server 360 at computer 370. The analysis server records this set of session page views in its database 380.

Independently of user 300's session (e.g., on a periodic basis) a user information system 390 sends data to analysis server 360 which details:
For each resource provided by web server 330, the type and worth of the content provided by that page. (For example, “This is a report which is worth $1” or “This is a menu page which is worth $0.”) Web pages may have a known value when the content provided is priced per report (e.g. in systems that offer pay-per-view as well as subscriptions) or when delivery of the content triggers a royalty payment to another party. Alternatively, page values may be assigned on the basis of the amount of data contained, the page's popularity with other users, or some other criteria.
For each user known by the system, the type of license sold and the amount that user paid to be able to use the application.

Analysis server 360 stores this information in its database 380. Subsequently, on demand or periodically, analysis server 360 sums the worth received by each user of the web service, by taking the sum of each page visited times the worth of that page:

Worth received by user=Σ(each page visited×worth of that page)

The value received by a user is then calculated by dividing the worth received by the amount the user paid to use the service:

$$Value received by user = \frac{Worth received by user}{Amount user paid to use service}$$

Another way of calculating the value received is to divide the number of resources provided by the amount the user paid to use the service:

$$Value received by user = \frac{Count of pages visited}{Amount user paid to use service}$$

Once the value received by each user is known, the analysis server creates an ordered list of the entire plurality of all users, ordered by their respective value received (a ranking like the sample shown in FIG. 2). Although the processes implementing web server 330, analysis server 360 and user information server 390 are shown executing on separate computers, those of ordinary skill will recognize that the processes may be co-located on a single computer or even in a single program, or their functions may be further sub-divided and distributed among cooperating computers in a variety of ways.

The following pseudo-code outlines the process of computing a value-ranking of a plurality of customers in a form familiar to software engineers:

10 function ComputeValueRank( CustomerList, HitList, LicenseList,

StartDate, EndDate )

20 ValueRankPeriod := EndDate − StartDate
30 FilteredHitList := HitList.Where( hit.Date between StartDate and

EndDate )

40 HitsByCustomer := dictionary( CustomerID, sum(FilteredHitList) )
50 NormalizedLicenseCostList := LicenseList / ValueRankPeriod
60 LicenseCostByCustomer := dictionary( CustomerID,

NormalizedLicenseCostList )

70 CustomerListWithDemand := combine ( HitsByCustomer,

LicenseCostByCustomer )

80 Result := Sort CustomerListWithDemand by CostPerHit
90 return Result

### Listing 1

This function computes a value ranking based on a number of input parameters. CustomerList is a list of all customers (indexed by some unique identifier CustomerID). HitList is a list of all “hits” by customers, where each “hit” represents a unit of value that we wish to include as a measure of the customer's demand. These hits may be web-page accesses, whitepaper downloads, video views, or any other activity that is considered an element of demand calculation. Each hit record includes: HitID, a unique identifier for the hit; Date, a date/time stamp for the hit; and CustomerID, to correlate with a customer in the CustomerList. (Hits may include other data of interest as well.) LicenseList is a list of all licenses sold to customers. Each license record in LicenseList typically includes: CustomerID to correlate with a customer in the CustomerList; Amount, a monetary cost of the license; and PeriodInDays, the duration of the license. StartDate and EndDate delimit the period for which the value rank should be prepared.

From these input data, the function calculates several derived measures: ValueRankPeriod, FilteredHitList (hits from within the time period of interest), HitsByCustomer (a key/value structure summing the number or value of hits by each CustomerID), and NormalizedLicenseCost (the license cost for each customer, normalized by the number of clays in the time period of interest). Next, CustomerListWithDemand is produced by iterating over CustomerList and associating each CustomerID with the quotient of HitsByCustomer and NormalizedLicenseCost (the quotient is CostPerHit). Finally, the CustomerListWithDemand is sorted by CostPerHit and returned as a value-ranking for use in subsequent processing.

Embodiments of the invention can collect information with greater or lesser degrees of detail, and the information can be collected automatically or by hand. For example, the health club mentioned earlier might simply have its desk reception staff note clays on which a subscriber visited to use the facilities, and compute the value received as the number of clays multiplied by the single clay-pass rate, divided by each patron's subscription rate. Alternatively, the same health club might install automatic exercise-tracking devices on the equipment and compute the value received as a function of the customer's effort expended or calories burned, divided by the subscription rate.

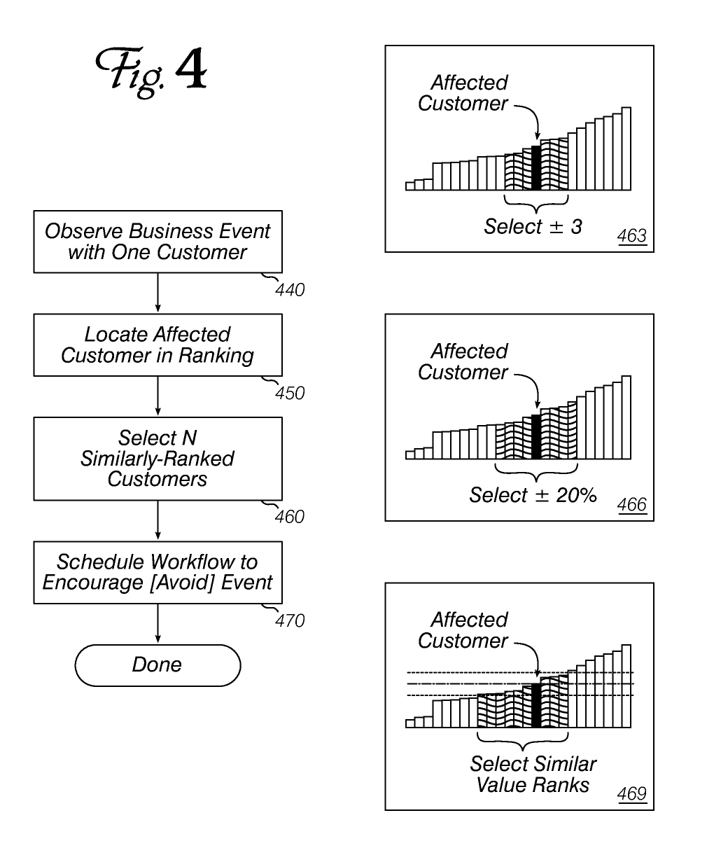

At any rate, after a value ranking is prepared, it can be used for several different business purposes. First, as discussed earlier, it can be used for making predictions, which can be converted into concrete, practical business actions. FIG. 4 outlines this use.

At 440, an event affecting the relationship between one of the customers in the ranking and the business is observed. For example, the customer may cancel, downgrade, or upgrade his subscription, or may purchase a different product or service offered by the business. Or, a new customer may subscribe, and give the existing customer's name as a referring party. Clearly, these are events that would be useful for the business to predict and attempt to control.

An embodiment of the invention locates the affected customer in the value ranking (450) and selects a number of similarly-ranked customers (460). For example, a fixed integral number of the affected customer's neighbors in the ranking (463), a percentage of the total number of customers whose ranks fall near the affected customer (466) or customers whose value ranks fall within a range of the affected customer's value rank (469) may be selected.

Finally, for the selected customers, the embodiment schedules a business workflow or task designed to increase (or reduce) the likelihood that the selected customers will also be involved in a business relationship change like that of the affected customer (470). For example, if the affected customer upgraded his subscription, purchased a different product, or recommended the business to the new customer, then the selected customers may be offered an incentive (or simply a reminder of an existing incentive) to make the same relationship change. If the affected customer downgraded or canceled his service, the selected customers may be contacted to assess their level of satisfaction with the good or service, or offered a rebate or discount (which would effectively raise their value ranking).

The scheduling can be accomplished by submitting a control message to a sales or workforce automation tool. For example, an appointment or meeting invitation can be transmitted to an automatic calendar management service for a salesperson or account manager of a selected customer. Alternatively, a queue of contact requests can be stored and doled out to agents on a first-in, first-out basis. Many businesses use an online sales automation tool accessible through the website http://www.salesforce.com. Appointments, calls and similar actions can be scheduled automatically by sending an appropriately-formatted electronic message from an embodiment using the value-ranking system. The message can be sent via an electronic-mail-like facility, through a Web Services API, or through some similar interface. The online tool may support tracking so that the outcomes of a particular set of predictions and responses can be reviewed to evaluate the accuracy of the value ranking and the effectiveness of the responses.

A second method of using the value ranking prepared according to an embodiment of the invention is in allocating resources for marketing and business development. These activities may be generally known as “lead development:” advertising and similar outreach programs designed to bring the company and its products or services to the attention of potential customers. A wide range of choices is available, from print, radio and television advertising; to trade shows, contests and giveaways. A value ranking prepared as described above, coupled with information about the lead channel that attracted the ranked customers, can provide useful insight into preferred marketing strategies to attract customers at a particular value rank.

Again, it is important to recall that the value rank of a customer is different from the amount of money the business receives from the customer, and is unrelated to the profitability of serving the customer. A business that wanted to attract the most profitable customers might simply use lead sources that attracted the lowest value-ranked customers (those who pay, but receive little worth), on the theory that those customers are the most profitable. However, those customers may also be the most likely to defect. On the other hand, the highest-ranked customers might appear to be the most expensive (and least profitable) to serve, but those customers might also be rich referral sources.

A business employing an embodiment of the invention for lead generation would select a customer or group of customers at a particular value rank, and allocate lead-development resources among the means that attracted the selected customers. For example, if 60% of the selected customers responded to a television ad, and 40% replied to an online banner ad, then the business could allocate its resources in similar proportion to recruit more customers who might fall near the same value rank in future rankings. Or, if the selected customers responded to a variety of different types of campaigns, then the campaigns can be ordered according to the number of customers each attracted, and the most effective campaign types could be repeated. It is appreciated that important distinctions can be found, even within a single type of advertising campaign. For example, online advertisements placed at different websites (or different types of websites) may attract different numbers or value-ranks of customers. An embodiment of the invention can help determine whether to place ads at a general-interest news website, a special-interest website, or an online store; or how to allocate an advertising budget among competing websites of a particular type. If highly-detailed information is captured and associated with customer records, the value rank can even suggest what season, time of clay, or ad placement location is better for attracting customers who may end up at a preferred location in a future value ranking.

In the foregoing discussion, a value ranking prepared according to an embodiment of the invention is described in a one-dimensional way: it is (roughly speaking) the sum of the worth received by each customer, divided by the cost paid by the customer. (The sample ranking of FIG. 2 is two-dimensional because the customers are displayed in sorted order; the sorting provides the second dimension.) However, it is appreciated that value rankings may change over time (for example, as customers change their usage of the product or service), and that the change in value ranking may expose additional information that can improve the predictions or planning of a business that relies on an embodiment of the invention.

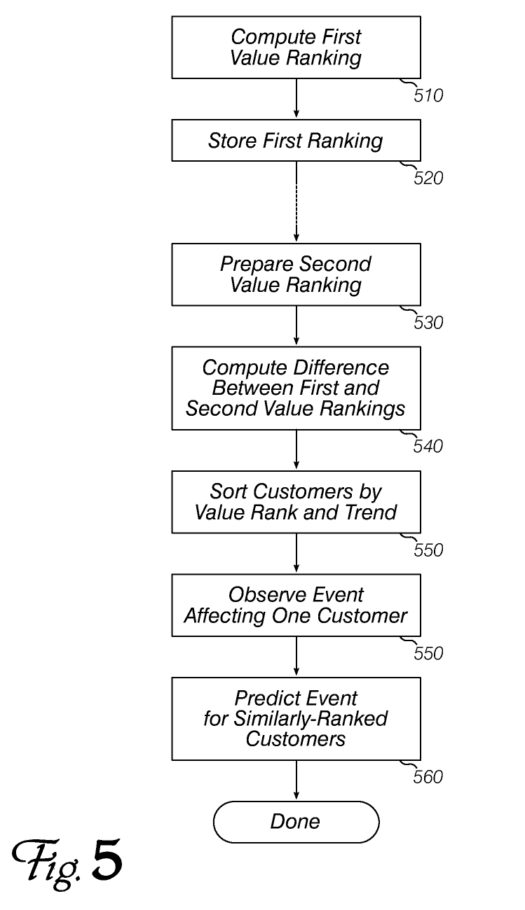

To take advantage of this time-varying information, an embodiment may be refined as described in FIG. 5: a first value ranking is computed (510), covering a first period of time. The results of this first ranking are stored (520) (or the predicate data is saved so that the ranking can be reproduced again later). Later, a second value ranking is prepared (530), and the difference between the first and second value rankings is computed (540). Finally, a two-dimensional ranking of the customers is prepared, where the first dimension is the customer's value rank (either the first or second value rank may be used) and the second dimension is the difference between the first and second rankings (i.e., the value trend) (550). As before, a final dimension is provided by the ordering or ranking process itself, so a representation of the graph is actually three-dimensional. This graph distinguishes between customers who may be at the same numeric value rank, but who have arrived at that rank by increasing or decreasing the effectiveness of their exploitation of the service (or by changes in their subscription fees).

Finally, as in the previous embodiments, an event affecting one of the customers is observed (560), and the same event is predicted for customers whose value ranks and value trends place them near the affected customer on the three-dimensional graph (570).

It is appreciated that the observation of an event affecting one of the customers need not occur during the period for which a value ranking is prepared (or thereafter). It is merely expedient to describe it that way, and it is believed to aid in understanding the invention. In fact, value ranking has proven to be useful in identifying similar customers, where the similarity is interesting or useful to a business serving those customers. If an interesting trait or proclivity of a customer is known for any reason (including the observation of a relevant event, but also from the results of a survey or other research activity), then better-than-chance accuracy is often found when nearby customers in a value ranking are treated as if they share the interesting trait. In addition, associations between value ranks and interesting traits may persist temporally, so that a prediction of a trait for customers near a particular value ranking at one time, may also be useful for predicting the trait for a subsequent customer who was not part of the original value ranking at all. In other words, if a group of customers with values received near 1.2 (to pick an arbitrary numerical example) are predicted to be good candidates for upsell, then a later customer whose value-received is near 1.2 may also be a good candidate for the same upsell. A business workflow could be scheduled to offer the upsell to the customer when it is noticed that his value received is 1.2.

Note that in most embodiments, the Value Rank is a ratio of two monetary amounts, so it is a dimensionless number. Its applicability across different types of business may be improved by converting the Value Rank to a standard score (or “z-score”) by normalizing the Value Rank to a number of standard deviations above or below the subscriber population (or relevant sub-population) mean or median. Normalizing in this way may make it possible to produce an embodiment that is generally useful to a wide range of businesses. Thus, for example, value ranking could be incorporated into a general salesforce/business-automation system designed to serve a range of industries. Such a system may include an interactive feature where customers can be sorted and displayed by value rank, and a user of the system can select the similarly-ranked customers and trigger the scheduling of workflow events.

Other features that may appear in an embodiment include
A system in which the worth of a resource provided by the web server is calculated automatically based on other known existing data, rather than being provided by a user information server.
A system in which the application is not a web application, but is a software application running on the user's local PC.
A system in which the web server, analysis server and user information server are all running on the same physical hardware and/or are all part of the same computer program. Alternatively, a system in which each server is a different program and may be running on different physical machines
A system in which the web server instructs the browser to notify the analysis server that a resource has been used, rather than sending the message to the analysis server directly.
A system in which the interesting traits are correlated to worth received by a user, rather than value received by user (i.e., independent of the user's subscription cost). This embodiment offers slightly reduced computational cost and may be appropriate, for example, when every subscriber's cost is equal.
A system in which a plurality of users are analyzed in a group (such as the company they work for), and worth, value, and value rank are calculated on group bases rather than for individual users.
A system in which the interesting traits measured are selected amongst: likelihood to stop using the product, likelihood to be receptive to up-sell or cross-sell opportunities to other products, likelihood to provide a positive review.
A system in which the interesting traits measured are any value of interest to the organization providing the product or service.
A system in which the unit of usage measured to calculate worth is not a page view, but instead may be a: session, a resource view, a time period of use, or any other measurable trait of a product or service

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that value ranking as described can also be produced by software and hardware that distribute the functions of embodiments of this invention differently than herein described. Such variations and implementations are understood to be captured according to the following claims.

We claim:

1. A method for scheduling sales activity to improve business outcomes comprising:
for each subscriber of a plurality of subscribers, computing a value received by the subscriber as a ratio of a worth of a product received by the subscriber to a subscription fee paid by the subscriber;
observing an event of interest in a first relationship between a company and a first subscriber of the plurality of subscribers;
identifying a second subscriber of the plurality of subscribers, where the first subscriber and the second subscriber have similar computed values received; and
scheduling a workflow item to alter a likelihood that the event of interest will occur with the second subscriber.

2. The method of claim 1 wherein the event of interest is one of canceling a subscription, renewing a subscription or purchasing a related item.

3. The method of claim 1 wherein the event of interest is referring a new customer.

4. The method of claim 1 wherein scheduling comprises transmitting an electronic message to cause an entry in an automatic calendar system.

5. The method of claim 1 wherein the worth of the product received by the subscriber is a sum of a per-unit price of products received by the subscriber during a period of time.

6. The method of claim 1 wherein the worth of the product received by the subscriber is proportional to an overall demand for the product during a period of time.

7. The method of claim 1 wherein the workflow item is to cause a salesperson to contact the second subscriber.

8. The method of claim 1 wherein the workflow item is to offer the second subscriber a reduced subscription cost.

9. The method of claim 1 wherein the product received by the subscriber is online access to real-estate data.

10. The method of claim 1 wherein the product received by the subscriber is access to a health club.

11. A method for focusing business-development resources on receptive customers, comprising:
recording information about activities of a plurality of customers to quantify a value each customer receives from a service;
computing a cost each customer incurs for using the service;
calculating a value rank quotient for each customer from the value the customer receives and the cost the customer incurs;
identifying a subset of the plurality of customers who have similar value rank quotients; and
scheduling a business workflow activity for each customer in the subset of the plurality of customers.

12. The method of claim 11, further comprising:
converting the value rank quotient for each customer to a normalized rank based on a number of standard deviations from a mean of the value rank quotients.

13. The method of claim 11, further comprising:
converting the value rank quotient for each customer to a normalized rank based on a number of standard deviations from a median of the value rank quotients.

14. The method of claim 13 wherein identifying a subset comprises selecting a subset of the plurality of customers whose normalized ranks are near a normalized rank of a foreign customer who purchases a different service.

15. The method of claim 11 wherein identifying a subset comprises selecting an integral number of customers whose value rank quotients are nearest to the value rank quotient of an affected customer.

16. The method of claim 11 wherein identifying a subset comprises selecting a portion of the plurality of customers whose value rank quotients are nearest to the value rank quotient of an affected customer.

17. The method of claim 11 wherein identifying a subset comprises selecting all customers whose value rank quotients fall within a numeric range of the value rank quotient of an affected customer.

18. A computer-readable medium containing instructions to cause a programmable processor to perform operations comprising:
recording information about delivery of data products to a plurality of online customers;
computing an estimated value received by each customer of the plurality of online customers, based on the recorded information;
accepting an identification of one of the plurality of online customers;
selecting a subset of the plurality of online customers wherein each customer of the subset has an estimated value-received near that of the identified customer; and
scheduling business workflows targeting each of the selected customers in the subset of the plurality of online customers.

19. The computer-readable medium of claim 18 containing additional instructions to cause the programmable processor to perform operations comprising:
computing an estimated value trend for each customer based on first estimated value for the customer over a first period of time and a second estimated value for the customer over a second, later period of time.

20. The computer-readable medium of claim 18 containing additional instructions to cause the programmable processor to perform operations comprising:
displaying multi-dimensional chart illustrating estimated value-received quantities for each customer, wherein
accepting an identification is accepting an interactive selection from the multi-dimensional chart.

21. The computer-readable medium of claim 18 wherein the data products are records of real estate activity.

22. A method for allocating limited lead-development resources comprising:
computing a dimensionless quantity representing a value received by each customer of a plurality of customers;
selecting a subset of the plurality of customers, where each customer of the subset has a similar dimensionless quantity;
identifying at least one lead-development channel by which the customers of the subset were initially attracted, and a proportion of the customers of the subset who were initially attracted by each of the at least one lead-development channel; and
allocating the limited lead-development resources in like proportion to the at least one lead-development channel.

23. The method of claim 22 wherein allocating comprises:
purchasing lead-development services from a provider of such services using a portion of the limited lead-development resources.

24. The method of claim 22 wherein the at least one lead-development channel comprises at least one of:
a television ad campaign;
a print ad campaign;
an online-banner-ad campaign; and
a direct-mail ad campaign.

25. The method of claim 22 wherein the at least one lead-development channel comprises at least one of:
a first online-banner-ad campaign where ads are displayed at a first website; and
a second online-banner-ad campaign where ads are displayed at a second, different website.

26. The method of claim 22, further comprising:
converting the dimensionless quantity of each customer to a Z-score as a number of standard deviations between the dimensionless quantity of the customer and a mean of the dimensionless quantities of the plurality of customers.

27. The method of claim 22 wherein the dimensionless quantity is a quotient of a sum of a worth of services received by each customer during a period of time and a cost paid by each customer during the period of time.

28. A marketing planning method comprising:
computing a value ranking of a plurality of subscribers to an online data service;
selecting a subset of the plurality of subscribers who have similar value-received measures;
identifying a plurality of lead-development channels that led to the subset of subscribers becoming customers of the online data service; and
purchasing marketing services similar to the lead-development channels that attracted a large proportion of the subset of subscribers.

29. The marketing planning method of claim 28 wherein the lead-development channels comprise television ads, print ads and online ads.

30. The marketing planning method of claim 28 wherein the lead-development channels consist of online ads placed at a plurality of websites.

31. A marketing channel selection method comprising:
purchasing ad placements in a plurality of venues, wherein the venues are selected in proportion to a number of subscribers near a value rank who were initially attracted by an ad at the venue.

32. The marketing channel selection method of claim 31 wherein the plurality of venues consists of a plurality of online websites.

33. A machine-readable medium containing instructions to cause a programmable processor to operate as an interactive marketing analysis and planning tool by performing operations comprising:
calculating a value-received measure for each subscriber of a plurality of subscribers to an online data service;
selecting a subset of the plurality of subscribers based on similarity of value-received measure; and
displaying a plurality of marketing channels, each marketing channel associated with at least one subscriber of the subset of the plurality of subscribers.

34. The machine-readable medium of claim 33, containing additional instructions to cause the programmable processor to perform operations comprising:
sorting the plurality of marketing channels according to a number of subscribers associated with each marketing channel.
